(19) United States
(12) Patent Application Publication
(10) Pub. No.: US 2021/0379704 A1
(43) Pub. Date: Dec. 9, 2021

(54) COMPOSITIONS BASED ON YTTRIUM, CERIUM AND AN ORGANIC COMPOUND, AND STOP-OFF USE THEREOF

(71) Applicant: RHODIA OPERATIONS, Aubervilliers (FR)

(72) Inventor: Franck AURISSERGUES, Argenteuil (FR)

(21) Appl. No.: 17/288,065

(22) PCT Filed: Oct. 29, 2019
(86) PCT No.: PCT/EP2019/079488

§ 371 Date: Apr. 23, 2021

(30) Foreign Application Priority Data
Nov. 2, 2018 (FR) 1860143
Nov. 2, 2018 (FR) 1860144

(51) Int. Cl. B23K 35/22; B23K 20/02

(52) U.S. Cl. CPC B23K 35/224; B23K 20/023

(57) ABSTRACT

The present invention relates to a composition based on yttrium oxide, on a cerium-based compound and on an organic compound and its use in the field of welding as stop-off product. The composition comprises, in an aqueous medium:
yttrium oxide particles;
particles of a cerium-based compound:
   which is cerium oxide; or
   which is prepared by the process consisting in causing a colloidal dispersion D, which is obtained by the neutralization of an aqueous cerium nitrate solution by a basic aqueous solution, to undergo heating;
an organic compound chosen from the group formed by polyvinylpyrrolidone, polyvinyl alcohol, carboxymethyl cellulose and hydroxyethyl cellulose.

The present patent application claims the priorities of French patent applications No. 1860143 and No. 1860144 filed on Nov. 2, 2018 and the contents of which are fully incorporated by reference. In the event of inconsistency between the text of the present patent application and one of the texts of the prior patent applications which would affect the clarity of a term or of an expression, reference will be made to the present patent application solely.

### TECHNICAL FIELD

The present invention relates to a composition based on yttrium oxide, on a cerium-based compound and on an organic compound and to its use in the field of welding as stop-off product.

### Technical Problem

The diffusion welding technique is a known technique described in detail, for example, in EP 1 466 692. This technique consists in bringing two sheets of a given material into contact at high temperature under a certain pressure and for a certain time. The welding of the two sheets then takes place by diffusion of atoms, which represents the advantage of forming a bonding structure equivalent to the base structure of the material.

In the case of a diffusion welding associated with a superplastic forming, a stop-off composition is used to prevent diffusion welding in the areas of the faces of the sheets located facing each other, which will subsequently be inflated. Thus, the stop-off composition forming a diffusion barrier is applied in predefined areas on at least one of the opposing faces of the sheets made of superplastic material (e.g. titanium) so that, on conclusion of the diffusion welding step, the sheets are not welded in the areas covered with the stop-off composition, which generally comprises a filler made of refractory material which inhibits the diffusion of the atoms of the sheets to be welded.

The stop-over composition has to exhibit a number of characteristics. It must be able to be applied easily and accurately to the sheet and accordingly exhibit appropriate physicochemical properties, in particular an appropriate viscosity. It should preferably not comprise toxic compound(s) and be stable over time. It must be able to adhere properly to the material and make it possible to obtain a firm and clean weld. The technical problem to be solved is thus that of developing such a composition.

### TECHNICAL BACKGROUND

U.S. Pat. No. 6,924,038 B1 describes a composition based on alumina, on titanium oxide and on silica. Yttrium oxide and cerium oxide are not described.

WO 2013/178963 describes a process for producing a metal reinforcement for a turbine engine blade.

EP 1 466 692 describes a stop-off composition based on yttrium oxide, the mean size of which is preferably at 50 μm. Reference is not made therein to a composition such as that of the invention.

EP 0266073 describes a stop-off composition based on yttrium oxide and on a polymer binder.

### DETAILED DESCRIPTION

As regards the composition of the invention, it comprises, in an aqueous medium:
yttrium oxide particles;
particles of a cerium-based compound:
   which is cerium oxide; or
   which is prepared by the process consisting in causing a colloidal dispersion D, which is obtained by the neutralization of an aqueous cerium nitrate solution by a basic aqueous solution, to undergo heating;
an organic compound chosen from the group formed by polyvinylpyrrolidone, polyvinyl alcohol, carboxymethyl cellulose and hydroxyethyl cellulose.

The composition according to the invention comprises yttrium oxide particles. These exhibit a D50 of less than or equal to 50.0 μm, more particularly of less than or equal to 20.0 μm, indeed even of less than or equal to 15.0 μm, indeed even more of less than or equal to 10.0 μm. The D50 is generally greater than or equal to 0.5 μm, indeed even greater than or equal to 1.5 μm, indeed even more greater than or equal to 2.0 μm. The D50 may be between 0.5 μm and 50.0 μm, more particularly between 2.0 μm and 20.0 μm, indeed even between 2.0 μm and 15 μm, indeed even more between 2.0 μm and 10.0 μm.

In a technique for implementing the diffusion welding process, at least one layer of the stop-off composition is applied to a surface of a sheet according to a predefined pattern and subsequently a localized sintering of the stop-over composition is carried out according to said predefined pattern by heating resulting from the localized application of a laser beam. Thus, the size of the yttrium oxide particles is appropriate to the thickness of the stop-off barrier after application of the laser beam.

The yttrium oxide particles may furthermore exhibit a D90 of less than or equal to 100.0 μm, more particularly of less than or equal to 50.0 μm, indeed even of less than or equal to 20.0 μm. The size parameters D50 and D90 are obtained by the laser diffraction technique using a volume distribution. D50 corresponds to the median diameter as conventionally understood in statistics, determined from a volume distribution of the diameters of the particles. It is thus the value for which, on the cumulative curve in volume of the distribution, 50% of the particles have a diameter of greater than D50 and 50% of the particles have a diameter of less than D50. D90 for its part corresponds to the diameter such that 90% of the particles have a diameter of less than or equal to D90. Use may be made, in order to measure D50 and D90, of the Malvern 3000 from Malvern Instruments, the manufacturer's recommendations being followed and the manufacturer's software being used to obtain such a distribution.

Preferably, the yttrium oxide exhibits a purity by weight of greater than or equal to 99.99%, indeed even of greater than or equal to 99.999%.

The composition according to the invention also comprises particles of a cerium-based compound. This compound may be cerium oxide. Cerium oxide is found commercially as a dispersion in water. See, for example, the 20% dispersion sold by Alfa Aesar https://www.fishersci.co.uk/shop/products/cerium-oxide-20-h2o-colloidal-dispersion-alfa-aesar-3/11399257 (size of the order of 10 nm).

The cerium-based compound may also be prepared by the process P consisting in causing a colloidal dispersion D, which is obtained by the neutralization of an aqueous cerium nitrate solution by a basic aqueous solution, to undergo heating.

This process P is described in EP 0208580. In this process P, an aqueous cerium solution is used which may be a Ce^{IV} nitrate solution or an aqueous ceric ammonium nitrate solution. The aqueous solution of Ce^{IV} salt may also comprise Ce^{III} nitrate but it is desirable for the molar proportion of Ce^{IV} to be at least 85% (that is to say Ce^{IV}/Ceₜₒₜₐₗ≥0.85). The aqueous solution of Ce^{IV} salt preferentially contains no or few impurities in the form of covalent anions, such as sulfate ions.

The concentration of the aqueous solution of Ce^{IV} salt is not critical. It may vary between 0.1 and 2 mol/l. It may be advantageous for questions of productivity to use a concentrated solution of Ce^{IV} salt at a concentration of between 1 and 2 moles per liter. The aqueous solution of Ce^{IV} salt generally exhibits some initial acidity. The concentration of H⁺ ions is not critical. Advantageously, it is between 0.1N and 4N, indeed even between 0.1N and 1N. A ceric nitrate solution obtained by the electrolytic oxidation process may advantageously be used. This process is described in the application FR 2570087.

Neutralization is carried out using a basic aqueous solution which may be an aqueous ammonia, sodium hydroxide or potassium hydroxide solution. Advantageously, an aqueous ammonia solution is used. This basic aqueous solution may exhibit a concentration of between 0.1N and 11N, indeed even between 0.1 N and 5N. The proportion between the basic solution and the cerium nitrate solution is such that there is no precipitation of cerium in a gelatinous form. Thus, the proportion between the basic solution and the solution of the cerium nitrate is preferably such that the degree of neutralization r is greater than or equal to 0.01 and less than or equal to 3.0. r may be more particularly between 1.2 and 1.8. r is defined by the formula (n₃−n₂)/n₁ in which:
n₁ represents the number of moles of Ce^{IV} in the colloidal dispersion D;
n₂ represents the number of moles of OH⁻ required to neutralize the acidity introduced by the aqueous solution of Ce^{IV} salt;
n₃ represents the number of moles of OH⁻ introduced by the basic aqueous solution.

The degree of neutralization reflects the colloidal state of the cerium^{IV}:
with r=4, Ce^{IV} precipitates in the gelatinous form;
with r=0, Ce^{IV} is in the ionic form;
with 0<r<4, Ce^{IV} is in the ionic and/or colloidal form.

The particles of the colloidal dispersion D which is thus obtained after neutralization exhibit a mean diameter d50 generally of less than 30 nm.

The heating of the colloidal dispersion D is carried out at a temperature of between 80° C. and 200° C., preferably between 90° C. and 150° C., indeed even between 90° C. and 110° C. The duration of the heating may vary between 2 and 45 hours, preferably between 2 and 24 hours.

On conclusion of the heating, an aqueous dispersion of cerium-based particles is recovered. This product may generally be represented by the formula (I):

Ce(M)ₓ(OH)_{y}(NO₃)_{z} (I)

in which:
M represents an alkali metal chosen from Na or K or else a quaternary ammonium radical;
x is between 0.01 and 0.2;
z is between 0.4 and 0.7;
y is defined by: y=4−z+x.

M is the element associated with the base used in the neutralization step. Thus, in the case where the neutralization is carried out with aqueous ammonia, M=NH₄.

After the heating step, it is possible to recover the solid by a liquid-solid separation operation, for example by filtration, before redispersing the solid in the aqueous medium. This solid may be optionally washed. It is also possible and desired to leave the particles in dispersion in the water to avoid any agglomeration.

For the two types of cerium-based compound which may be used in the context of the invention, the cerium-based particles exhibit a crystalline phase of CeO₂ type. This crystalline phase is determined using X-ray diffraction. More particularly, the particles prepared with the process P described above are composed of a poorly crystallized product, more specifically of a product having a degree of crystallization which may vary from 30% to 70%. For these same particles, the unit cell parameter may vary from 5.42 to 5.44 angstroms. In the crystallized part of these particles, the size of the crystallites is generally less than 60 angstroms.

The cerium-based particles of the composition exhibit a d50 of less than or equal to 200 nm, more particularly of less than or equal to 100 nm, indeed even of less than or equal to 15 nm, indeed even more of less than or equal to 10 nm. The d50 is generally greater than or equal to 1 nm. The d50 may be between 1 nm and 200 nm, more particularly between 1 nm and 100 nm, indeed even between 1 nm and 15 nm, indeed even more between 1 nm and 12 nm or between 5 nm and 12 nm. The size parameter d50 is obtained by the dynamic light scattering (DLS) technique. d50 corresponds to the median diameter as conventionally understood in statistics, determined from a volume distribution of the diameters of the particles. It is thus the value for which, on the cumulative curve by volume of the distribution, 50% of the particles have a diameter of greater than d50 and 50% of the particles have a diameter of less than d50. Use may be made of the Zetasizer Nano ZS from Malvern Instruments to measure d50, the manufacturer's recommendations being followed and the manufacturer's software being used in order to obtain such a distribution.

The organic compound of the composition according to the invention is chosen from the group formed by polyvinylpyrrolidone, polyvinyl alcohol, carboxymethyl cellulose and hydroxyethyl cellulose. It is more particularly polyvinylpyrrolidone or polyvinyl alcohol.

In the present patent application, polyvinylpyrrolidone denotes a polymer which comprises units of formula:

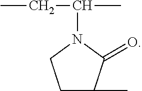

It may be a homopolymer of vinylpyrrolidone of formula

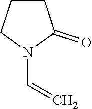

or a copolymer of vinylpyrrolidone and of at least one other comonomer which may be copolymerized with vinylpyrrolidone, such as, for example, acrylic acid or an alkyl acrylate. In the context of the present invention, the weight-average molecular weight (M_{w}) of the polyvinylpyrrolidone may be between 10000 g/mol and 50000 g/mol, more particularly between 10000 g/mol and 40000 g/mol, indeed even between 10000 g/mol and 30000 g/mol.

Polyvinyl alcohol is a polymer consisting of the units of formula: —CH₂—CHOH—. It may thus be represented by the formula: —(CH₂CHOH)ₙ— in which n represents the number of units. Polyvinyl alcohol is obtained in a known way by alkaline hydrolysis (sodium hydroxide, potassium hydroxide) of polyvinyl acetate. It is referenced by the following CAS number: 9002-89-5. In the case where the hydrolysis is not complete, it is not excluded for the polyvinyl alcohol to also comprise residues of vinyl acetate units. This is the case, for example, with the polyvinyl alcohol used in the examples, which exhibits a degree of hydrolysis of 98%. It is thus possible to use a polyvinyl alcohol for which the degree of hydrolysis is generally greater than 90%, indeed even than 95%, indeed even more than 97%. This degree may be determined using analytical techniques known to a person skilled in the art, such as, for example, proton NMR.

In the context of the present invention, the weight-average molecular weight (M_{w}) of the polyvinyl alcohol may be between 10000 g/mol and 100000 g/mol, more particularly between 20000 g/mol and 80000 g/mol, indeed even between 20000 g/mol and 60000 g/mol or between 30000 g/mol and 50000 g/mol. It is also possible to use a polyvinyl alcohol, the M_{w} of which is between 10000 g/mol and 50000 g/mol, more particularly between 10000 g/mol and 30000 g/mol. As is described in the examples, good results have been obtained with an M_{w} of less than or equal to 30000 g/mol.

M_{w} denotes the weight-average molecular weight and is determined by the size exclusion chromatography (or GPC) technique. The measurement conditions are known to a person skilled in the art. For the organic compounds of the invention, an aqueous mobile phase and a refractometric detector are generally used. Polyethylene glycol (PEG) standards are also generally used to obtain the calibration curve. A person skilled in the art may refer to the work Column Handbook for Size Exclusion Chromatography, Academic Press, ISBN 0-12-76555-7, to determine the GPC measurement conditions.

Specific conditions may be as follows. For polyvinylpyrrolidone, the following conditions may be used, for example: Acclaim SEC-1000 column from Thermofischer (4.6×300 mm); mobile phase: 10 mM sodium perchlorate solution; flow rate: 0.35 ml/min; temperature: 30° C.; detector:refractometer. Further details on the determination of M_{w} may be found in the booklet from Thermofischer available at the following address: https://assets.thermofisher.com/TFS-Assets/CMD/Specification-Sheets/D21517˜.pdf. For polyvinyl alcohol, the following conditions may be used: ultrahydrogel column; mobile phase:methanol:water 1:1; detector:refractometer.

The aqueous medium of the composition according to the invention comprises water. The aqueous medium may be water or may consist of a mixture of water and of at least one water-miscible liquid organic compound. The term “liquid” denotes the physical state of the organic compound at 25° C. and under 1 atmosphere. The term “water-miscible” means miscible at 25° C. in any proportion with water. The organic compound may, for example, be an alcohol, such as ethanol or propanol, or a ketone, such as acetone or butanone. The aqueous medium may also comprise soluble compounds which originate from the yttrium oxide particles or from the particles of the cerium-based compound. Thus, the aqueous medium may comprise free nitrate anions originating from the cerium-based compound prepared by the process P described above.

The aqueous medium may also consist of water and of at least one organic compound chosen from the group formed of alcohols, ketones, carboxylic acids and esters of carboxylic acids, the organic compound/water ratio by weight being between 0.1/99.9 and 30/70, more particularly between 0.1/99.9 and 20/80, indeed even between 0.1/99.9 and 10/90. The invention also applies to the case where use is made of an aqueous medium consisting of water and of several organic compounds chosen from the group formed of alcohols, ketones, carboxylic acids and esters of carboxylic acids, the organic compounds/water ratio by weight being between 0.1/99.9 and 30/70, more particularly between 0.1/99.9 and 20/80, indeed even between 0.1/99.9 and 10/90.

It should thus be noted that the invention makes it possible to provide a composition formulated on an aqueous base which thus does not present the risk of flammability or of toxicity of known stop-off compositions which contain large amounts of organic compounds, such as, for example, the Stopyt 62A composition, which comprises, by weight, from 30% to 40% of isopropyl alcohol, from 10% to 50% of methyl isobutyl ketone and less than 10% of 2-ethylhexyl phthalate. The phthalate presents a recognized toxicity or the composition described in EP 0266 073 which comprises butyl cellulose acetal.

The proportions by weight of the components of the composition may be as follows. These proportions are given by weight, with respect to the total weight of the composition. The proportion by weight of the yttrium oxide may be between 25.0% and 50.0%, more particularly between 30.0% and 50.0%, indeed even more particularly still from 35.0% to 45.0%, indeed even more between 37.0% and 43.0%. The proportion by weight of the cerium-based particles may be between 1.0% and 10.0%, more particularly between 1.0% and 7.0%, indeed even more particularly still from 1.0% to 5.0%, indeed even more between 2.0% and 5.0%.

The proportion by weight of the organic compound may be between 0.1% and 5.0%, more particularly between 0.1% and 2.0%, indeed even more particularly still from 0.1% to 1.0%, indeed even more between 0.1% and 0.5%. It should be noted that the proportion of the organic compound is low, which makes it possible to avoid the discharge of toxic organic compounds, in particular during the diffusion welding.

More particularly, the composition of the invention consists essentially of a mixture, in an aqueous medium:
of yttrium oxide particles;
of the particles of a cerium-based compound:
   which is cerium oxide; or
   which is prepared by the process consisting in causing a colloidal dispersion D, which is obtained by the neutralization of an aqueous cerium nitrate solution using a basic aqueous solution, to undergo heating;
of an organic compound chosen from the group formed by polyvinylpyrrolidone, polyvinyl alcohol, carboxymethyl cellulose and hydroxyethyl cellulose.

More particularly still, the composition of the invention consists of a mixture, in an aqueous medium:
of yttrium oxide particles;
of the particles of a cerium-based compound:
   which is cerium oxide; or
   which is prepared by the process consisting in causing a colloidal dispersion D, which is obtained by the neutralization of an aqueous cerium nitrate solution using a basic aqueous solution, to undergo heating;
of an organic compound chosen from the group formed by polyvinylpyrrolidone, polyvinyl alcohol, carboxymethyl cellulose and hydroxyethyl cellulose.

The composition of the invention generally exhibits a pH of greater than 7, more particularly of between 8 and 10.

Everything which has been seen above applies more particularly to particles of a cerium-based compound which is prepared by the process P described above and to polyvinyl alcohol.

According to one embodiment, which may be combined with everything which has been described above, the composition of the invention does not comprise zirconium oxide and/or hafnium oxide.

The composition of the invention may be prepared by the following process: An aqueous dispersion of cerium-based particles, to which dispersion water will optionally have been added, and the organic compound are stirred together. Yttrium oxide, in the form of a dry powder, is subsequently added with stirring to the mixture thus obtained. In order to obtain a composition which is homogeneous, use is advantageously made of a shearing stirrer, such as, for example, a stirrer of UltraTurrax or Rayneri type. Depending on the nature and the molecular weight of the organic compound, it may be preferable to carry out the stirring of the ingredients at a temperature greater than ambient temperature, for example at a temperature of between 40° C. and 90° C. This makes it possible for the dissolution of the polymer in the water and for the achievement of a homogeneous composition to be promoted.

Bringing the aqueous dispersion of the cerium-based particles into contact with the yttrium oxide should not lead to instability of the composition (separation by settling of the particles at the bottom of the flask). From this point of view, it should be noted that the aqueous dispersion of the cerium-based particles which is prepared by the process P generally exhibits a pH of between 0 and 1, indeed even in the vicinity of 1. It has unexpectedly been found that, although this aqueous dispersion is rather stable at acidic pH, it is possible to obtain a composition according to the invention exhibiting a pH between 8 and 10 which is stable over time (that is to say not exhibiting separation by settling of the particles).

The composition of the invention may exhibit a viscosity, measured at 20° C., of between 1.0 and 100.0 Pa·s, more particularly between 1.0 and 50.0 Pa·s, when the shear rate is equal to 1 s⁻¹. The composition of the invention may exhibit a viscosity, measured at 20° C., of between 0.1 and 10.0 Pa·s, more particularly between 0.1 and 5.0 Pa·s, when the shear rate is equal to 10 s⁻¹. The composition of the invention may thus be provided in the form of a fluid composition or of a paste.

### With Regard to the Use of the Composition of the Invention

The composition of the invention as described above may be used as stop-off product. The composition as described above may be used to form a diffusion barrier, in particular in a diffusion welding process.

This stop-off product is used in a process for the diffusion welding of two metal parts. The process consists in bringing into contact two metal parts, in particular in the form of sheets, compressed against each other and heated to a temperature suitable for causing diffusion of the metal atoms, the stop-off composition of the invention having been applied to at least one area of the faces of the parts located facing each other, so that, on conclusion of the heating step, the parts are not welded in the area(s) covered with said composition. The parts may be titanium or made of a titanium-based alloy. The temperature to which the parts are heated is generally at least 700° C., indeed even at least 800° C.

A specific process using the composition of the invention is described in claims 26-28. This process is a process for the manufacture of a hollow mechanical part by diffusion welding and superplastic forming, comprising the following steps:

a) provision of at least two primary parts made of superplastic material;

b) deposition, according to a predefined pattern, of a stop-off composition on at least one face of said primary parts;

c) assembly of the primary parts at their periphery with the exception of a location forming a passage, said primary parts forming a stack while delimiting between them, in pairs, a cavity, said at least one face, on which said stop-off composition was deposited in step b), being positioned facing said cavity;

d) diffusion welding of the stack under isostatic pressure;

e) placing the welded assembly in a mold;

f) bringing said mold to the superplastic forming temperature and injection under the superplastic forming pressure of an inert gas by said passage into said cavity, which causes inflation of the stack and superplastic forming, making it possible to obtain a blank of the mechanical part;

step b) being carried out by the sequence of the following steps:

b1) application over the entire surface of said at least one face of the primary parts of a layer of the stop-off composition of the invention as described above;

b2) localized sintering of the stop-off composition according to said predefined pattern by heating resulting from the localized application of a laser beam following a layout

composed of at least one area, whereby there are created, in said at least one area, on the one hand bonds between the particles of the composition and, on the other hand, a phenomenon of diffusion between the particles of the composition and the material of said at least one face of the primary parts;

b3) removal of the stop-off composition in the regions not subjected to the laser beam.

This process is targeted at responding to the following technical problem. The diffusion welding technique consists in bringing two sheets of a given material into contact at high temperature under a certain pressure and for a certain time. The welding of the two sheets then takes place by diffusion of atoms, which exhibits the advantage of forming a bonding structure equivalent to the base structure of the material. In the case of a diffusion welding associated with a superplastic forming, a stop-off composition is used to prevent diffusion welding in the areas of the faces of the sheets located facing each other, which will subsequently be inflated in order to obtain a hollow mechanical part. Thus, the stop-off composition forming a diffusion barrier is applied in predefined areas on at least one of the opposing faces of the sheets made of superplastic material (e.g. made of titanium) so that, on conclusion of the diffusion welding step, the sheets are not welded in the areas covered with the stop-off composition, which generally comprises a filler made of refractory material which inhibits the diffusion of the atoms of the sheets to be welded.

The assembly of sheets selectively welded by diffusion welding is then generally subjected to a superplastic forming by heating the assembly to a temperature compatible with a superplastic behavior of the material of the sheets, in a generally closed mold. An inert gas is subsequently injected under a controlled pressure into the nonwelded areas of the assembly, thus making possible an inflation of the sheets according to the profile of the mold.

Very obviously, the quality of the welding resulting from the diffusion welding step depends on the operating parameters: temperature, pressure and time, but also on the parameters related to the elements to be assembled: metallurgical structure, surface condition (cleanliness, roughness). Consequently, it is essential to eliminate any source of contamination from the surfaces to be assembled before bringing to the temperature of the diffusion welding step.

This cleaning of the surfaces is conventionally carried out by placing the cavity formed by the two surfaces to be welded under vacuum. However, in the case of a diffusion welding associated with a superplastic forming, use is made of a stop-off composition composed of a binder, generally an organic binder, and of a powder of a stop-off material formed of a filler made of refractory material, such as a ceramic (for example yttrium oxide, alumina or also boron nitride or graphite). This stop-off material inhibits the diffusion of the atoms of the materials of the sheets to be welded.

After application of the stop-off composition according to a predefined pattern corresponding to the areas of the surfaces not to be joined by diffusion welding, the binder is generally degraded so as to retain only the powder of the stop-off product, which exhibits the stop-off properties. This application of the stop-off composition is generally carried out by the known technique of screen printing which exhibits disadvantages which are recalled in EP 1 466 692.

The present invention is targeted at providing an improvement to the process described in EP 1 466 692 by the use of a novel stop-off composition exhibiting specific physicochemical and adhesion properties.

This process is easy to implement owing to the fact that it makes it possible to simplify the deposition step since it is possible to directly deposit the stop-off composition without the intermediary of a screen printing screen or of a layer of masking product.

It should be noted that the sintering makes it possible to produce good adhesion of the stop-off composition to the affected face(s) of the primary part(s), which completely eliminates the risks of migration of stop-off particles into the areas which are to be welded by diffusion welding. It should also be noted that the step of sintering by a laser beam induces a heating which makes it possible to degrade the organic compound of the composition, and thus to remove it. The principle of the sintering of an inorganic powder by a laser beam is presented in the application FR 2772021 in the context of a marking application, in particular a decorative application.

According to another preferential arrangement, step b1) of application of a layer of the stop-off composition is carried out by a method known to a person skilled in the art, for example by spraying, coating, screen printing, and the like. This arrangement may be implemented in a simple way by means of spray nozzles which directly project the stop-off composition over the entire surface of said at least one face of the primary parts consisting of sheets.

According to a preferential embodiment, the sintering step b2) is carried out under air or, preferably, under a neutral atmosphere (of inert gas), in particular under an argon atmosphere.

Preferably, step b3) of removal of the unsintered product is carried out by a nonabrasive operation, and this in order not to damage the surfaces which have to be welded by diffusion welding. In particular, according to a preferred arrangement, step b3) of removal of the unsintered product is carried out by washing, which constitutes a very simple means. This step b3) of removal of the unsintered product may also be carried out by any other action, in particular mechanical, which is nonabrasive, such as brushing.

According to another preferential arrangement, the laser is directed by a computer-controlled guiding system as is already known in the field of laser marking. Also, it is advantageously provided that, for each area of the layout, said guiding system starts the course of the corresponding portion of the layout inside said area. In this way, the risk of point defects (which may be due to the prolonged application of the laser beam) on the edge of the areas covered with the sintered stop-off composition, that is to say at the interface of the welded and nonwelded areas, is eliminated

The laser beam is adjusted so that it introduces sufficient energy to carry out the sintering of the particles of the stop-off composition, without carrying out the complete melting of the particles and while creating a phenomenon of diffusion between the sintered stop-off composition and the material on which the composition is deposited. The laser beam also makes it possible to remove the water from the stop-off composition and to degrade and to remove the organic compound present in said composition.

After passage of the laser, it is possible to remove the stop-off composition by any appropriate mechanical process (wiping, brushing, and the like) or also by immersion in a liquid subjected to a stream of ultrasound.

The present invention also relates to a manufacturing process as defined above, characterized in that said mechanical part is a hollow blade of a turbine engine, in particular a fan rotor blade, and in that, in step a), three primary parts composed of a suction-face primary part, of a central plate and of a pressure-face primary part are provided. The three primary parts are formed of sheets.

The subsequent steps of the process (after step b3)) are known and are as follows:

c) the primary parts (suction-face primary part, central plate and pressure-face primary part), stacked beforehand, are assembled at their periphery, with the exception of a location forming a passage;

d) the welding of the stack is carried out by diffusion welding in an isostatic compression chamber, so as to ensure intimate bonding between the constituent primary parts of the blade, except at the location of the abovementioned passage and areas covered with the layer of the sintered stop-off composition;

e) the assembly thus welded is placed in a mold;

f) the forming of the constituent primary parts of the blade is carried out under superplastic conditions by applying an inflation pressure in the internal cavity so as to obtain the desired profile.

This process is applicable to the production of other hollow mechanical parts, in particular wings, housings, covers, girders or any other hollow mechanical part, which is optionally structural.

### Examples

The yttrium oxide is a commercial product of 4N quality purchased commercially. D50=8 μm.

The aqueous dispersion of the cerium-based compound (denoted DA1) used in the preparation of the compositions of the examples was prepared by a neutralization/heating process, according to the teaching of EP 0208580, in particular that of the examples of this patent application, more particularly that of example 1 (heating at 100° C.). A colloidal dispersion with a d50=10.6 nm was obtained.

The polyvinyl alcohol used is sold by Sigma-Aldrich and exhibits a weight-average molecular weight M_{w} of less than 30000 g/mol. The polyvinylpyrrolidone used is a vinylpyrrolidone homopolymer sold by Sigma-Aldrich and exhibits a weight-average molecular weight M_{w} of the order of 40000 g/mol.

Viscosity measurement: a Kinexus Malvern plane rheometer was used. The viscosity measurements were carried out at 20° C. For each measurement, the sample is stirred briefly by shaking the flask. 15 drops, equivalent to approximately 0.9 g of product, are deposited and there is a wait for the air bubbles to disappear before starting the measurement.

Measurement of the Adhesion to Stainless Steel Sheets

The adhesion measurements were carried out in the following way. A film of the test composition is formed, using an automatic film applicator, on a metal sheet with a thickness of 100 μm. The sheets are subsequently stored at 120° C. for 10 min. Commercial adhesive tape is subsequently deposited on the film in order to adhesively bond it uniformly over the latter. Pressing is carried out twice with the fingers in order to cause it to adhere and then the adhesive tape is torn off.

The degree of tearing off is subsequently calculated in the following way:

T=(W4−W3)/(W2−W1)×100

W1: weight of the sheet without composition

W2: weight of the sheet with the composition

W3: weight of the adhesive tape used

W4: weight of the adhesive tape after tearing off containing composition which has been torn off from the sheet

The lower the degree of tearing off T, the better the adhesion of the composition to the sheet.

Example 1: water (27.67 g) and the aqueous cerium oxide dispersion DA1 (208.33 g of dispersion representing 3% of CeO₂ in the final composition) are introduced into a 1 liter polyethylene container, and then the PVP (4.0 g) is added with stirring over 15 min. A Rayneri stirrer at the speed of 500 rpm is used for this. The yttrium oxide (160.0 g in the powder form D50=8.0 μm) is subsequently added, still with stirring (700 rpm), over a period of time of 10 min and the stirring is increased from 5700 rpm to 1000 rpm. 400 g of a composition according to the invention are thus obtained.

Example 2: for the compositions based on polyvinyl alcohol, a similar procedure to that described in example 1 was used. The DA1/polyvinyl alcohol mixture was heated with stirring at 50° C. for 90 minutes before adding the yttrium oxide.

The other compositions of table I are prepared according to a procedure identical to those described in example 1 or example 2.

TABLE I

| | | | % organic compound | | | | |
|---|---|---|---|---|---|---|---|
| | | % cerium- | | | hydroxy- | carboxy- | |
| | % | based | | polyvinyl | ethyl | methyl | T |
| Ex. | Y₂O₃ | compound | PVP | alcohol | cellulose | cellulose | (%) |
| ref | 40 | 3 | 0 | 0 | 0 | 0 | 25% |
| 1 | 40 | 3 | 1 | 0 | 0 | 0 | 16% |
| 2 | 40 | 3 | 5 | 0 | 0 | 0 | 6% |
| 3 | 40 | 3 | 0 | 0.5 | 0 | 0 | 7% |
| 4 | 40 | 3 | 0 | 1 | 0 | 0 | 8% |
| 5 | 40 | 3 | 0 | 0 | 0.1 | 0 | 22% |
| 6 | 40 | 3 | 0 | 0 | 0 | 0.2 | 22% |
| 7 | 40 | 3 | 0 | 0 | 0 | 0.5 | 24% |

D50 = 8 μm; d50 = 10 nm; aqueous medium: water; % are given by weight with respect to the composition as a whole 98% hydrolyzed polyvinyl alcohol with an M_{w} of 13 000-23 000 g/mol from Sigma-Aldrich (ref. 348406)

It may be observed that, compared with the composition without organic compound (reference), the compositions of examples 1 to 7 exhibit a better degree of tearing off. Among the organic compounds, PVP and polyvinyl alcohol are the most advantageous because the degree of tearing off may be less than 10%.

Very good results are obtained with the polyvinyl alcohol used since the degree of tearing off is low, this being the case for a small amount of organic compound (0.5%). A small amount of organic compound makes it possible to avoid the production at high temperature of compounds which are harmful to the welding.

Compositions have also been prepared with yttrium oxide particles exhibiting another D50. For a D50=1 μm, the composition is very viscous. For a D50=3 μm, the composition exhibits a lower viscosity. Thus, D50 is preferably greater than or equal to 1.5 μm, indeed even greater than or equal to 2.0 μm.

1. A composition comprising, in an aqueous medium:
yttrium oxide particles;
particles of a cerium-based compound:
which is cerium oxide; or
which is prepared by a process consisting of causing a colloidal dispersion D, which is obtained by the neutralization of an aqueous cerium nitrate solution by a basic aqueous solution, to undergo heating;
an organic compound selected from the group consisting of polyvinylpyrrolidone, polyvinyl alcohol, carboxymethyl cellulose and hydroxyethyl cellulose.

2. The composition as claimed in claim 1, consisting essentially of or consisting of a mixture, in an aqueous medium:
of the yttrium oxide particles;
of the particles of a cerium-based compound:
which is cerium oxide; or
which is prepared by a process consisting of causing a colloidal dispersion D, which is obtained by the neutralization of an aqueous cerium nitrate solution by a basic aqueous solution, to undergo heating;
of an organic compound selected from the group consisting of polyvinylpyrrolidone, polyvinyl alcohol, carboxymethyl cellulose and hydroxyethyl cellulose.

3. The composition as claimed in claim 1, wherein the composition does not comprise zirconium oxide and/or hafnium oxide.

4. (canceled)

5. The composition as claimed in claim 1, wherein the yttrium oxide particles exhibit a D50 of less than or equal to 50.0 μm, D50 denoting the median diameter of a volume distribution and being obtained by a laser diffraction technique.

6. The composition as claimed in claim 1, wherein the yttrium oxide particles exhibit a D50 of between 0.5 μm and 50.0 μm, D50 denoting the median diameter of a volume distribution and being obtained by a laser diffraction technique.

7. The composition as claimed in claim 1, wherein the aqueous cerium nitrate solution is a solution of Ce^{IV} nitrate, optionally comprising Ce^{III} nitrate, the molar proportion of Ce^{IV} being in this case at least 85%.

8. The composition as claimed in claim 1, wherein the basic aqueous solution is an aqueous ammonia, sodium hydroxide or potassium hydroxide solution.

9. (canceled)

10. The composition as claimed in claim 1, wherein the proportion between the basic solution and the solution of the cerium nitrate is such that the degree of neutralization r is greater than or equal to 0.01 and less than or equal to 3.0, r being defined by the formula (n₃−n₂)/n₁ in which:
n₁ represents the number of moles of Ce^{IV} in the colloidal dispersion D;
n₂ represents the number of moles of OH⁻ required to neutralize the acidity introduced by the aqueous solution of Ce^{IV} salt;
n₃ represents the number of moles of OH⁻ introduced by the basic aqueous solution.

11. The composition as claimed in claim 1, wherein the heating of the colloidal dispersion D is carried out at a temperature of between 80° C. and 200° C.

12. (canceled)

13. The composition as claimed in claim 1, wherein the cerium-based particles exhibit a d50 of less than or equal to 200 nm, d50 denoting the median diameter of a volume distribution and being obtained by a dynamic light scattering technique.

14. (canceled)

15. The composition as claimed in claim 1, wherein:
the weight-average molecular weight (M_{w}) of the polyvinylpyrrolidone is between 10 000 g/mol and 50 000 g/mol;
the weight-average molecular weight (M_{w}) of the polyvinyl alcohol is between 10 000 g/mol and 100 000 g/mol.

16. The composition as claimed in claim 1, wherein the weight-average molecular weight (M_{w}) of the polyvinyl alcohol is between 10 000 g/mol and 50 000 g/mol.

17. The composition as claimed in claim 1, wherein the proportion by weight of the yttrium oxide is between 25.0% and 50.0%.

18. The composition as claimed in claim 1, wherein the proportion by weight of the cerium-based particles is between 1.0% and 10.0%.

19. The composition as claimed in claim 1, wherein the proportion by weight of the organic compound is between 0.1% and 5.0%.

20. The composition as claimed in claim 1, exhibiting a pH of greater than 7.

21. The composition as claimed in claim 1, exhibiting a viscosity, measured at 20° C., of between 1.0 and 100.0 Pa·s, when the shear rate is equal to 1 s⁻¹; or a viscosity, measured at 20° C. of between 0.1 and 10.0 Pa·s, when the shear rate is equal to 10 s⁻¹.

22. (canceled)

23. (canceled)

24. (canceled)

25. A process for the diffusion welding of two metal parts, the process consisting of bringing into contact two metal parts compressed against each other and heated to a temperature suitable for causing diffusion of the metal atoms, the composition as defined in claim 1 having been applied as stop-off composition to at least one area of the faces of the parts located facing each other, so that, on conclusion of the heating step, the parts are not welded in the area(s) covered with said composition.

26. A process for the manufacture of a hollow mechanical part by diffusion welding and superplastic forming, the process comprising the following steps:
a) providing at least two primary parts made of superplastic material;
b) depositing, according to a predefined pattern, a stop-off composition on at least one face of said primary parts;
c) assembling the primary parts at their periphery with the exception of a location forming a passage, said primary parts forming a stack while delimiting between them, in pairs, a cavity, said at least one face, on which said stop-off composition was deposited in step b), being positioned facing said cavity;
d) diffusion welding the stack under isostatic pressure;
e) placing the welded assembly in a mold;
f) bringing said mold to the superplastic forming temperature and injection under the superplastic forming pressure of an inert gas by said passage into said cavity, which causes inflation of the stack and superplastic forming, making it possible to obtain a blank of the mechanical part;
step b) being carried out by the sequence of the following steps:
b1) applying a layer of the stop-off composition over the entire surface of said at least one face of the primary parts;
b2) localized sintering the stop-off composition according to said predefined pattern by heating resulting from the localized application of a laser beam following a layout composed of at least one area, whereby there are created, in said at least one area, on the one hand bonds between the particles of the composition and, on the other hand, a phenomenon of diffusion between the particles of the composition and the material of said at least one face of the primary parts;
b3) removing the stop-off composition in the regions not subjected to the laser beam,
wherein the stop-off composition is the composition of claim 1.

27. (canceled)

28. The process as claimed in claim 26, wherein the process comprises the following steps, after step b3):
c) assembling the primary parts, stacked beforehand, at their periphery, with the exception of a location forming a passage;
d) carrying out the welding of the stack by diffusion welding in an isostatic compression chamber, so as to ensure intimate bonding between the constituent primary parts of the blade, except at the location of the abovementioned passage and areas covered with the layer of the sintered stop-off composition;
e) placing the assembly thus welded in a mold;
f) carrying out the forming of the constituent primary parts under superplastic conditions by applying an inflation pressure in the internal cavity so as to obtain the desired profile.
